(19) United States
(12) Patent Application Publication
(10) Pub. No.: US 2023/0245171 A1
(43) Pub. Date: Aug. 3, 2023

(54) AUTOMATICALLY DETERMINING BY A FEDERATED SEARCH ADS TO BE PRESENTED ON A USER INTERFACE

(71) Applicant: Walmart Apollo, LLC, Bentonville, AR (US)

(72) Inventors: Yichuan Niu, Newark, CA (US); Biyi Fang, Palo Alto, CA (US); Yangbing Xue, Sunnyvale, CA (US); Kritika Upreti, Sunnyvale, CA (US); Ashutosh Singh, Sunnyvale, CA (US); Vivek Kumar, Bellevue, WA (US); Haibo Yan, Pleasanton, CA (US); Valeriy V. Pelyushenko, San Jose, CA (US); Rajesh Garigipati, Dublin, CA (US); Jayanth Korlimarla, Sunnyvale, CA (US); Dong Xu, Sunnyvale, CA (US); Musen Wen, Mountain View, CA (US); Stephen Dean Guo, Saratoga, CA (US)

(73) Assignee: Walmart Apollo, LLC, Bentonville, AR (US)

(21) Appl. No.: 17/589,873

(22) Filed: Jan. 31, 2022

(51) Int. Cl. G06Q 30/02; G06F 40/30

(52) U.S. Cl. CPC G06Q 30/0257; G06Q 30/0246; G06F 40/30

(57) ABSTRACT

A method implemented via execution of computing instructions configured to run at one or more processors and stored at one or more non-transitory computer-readable media. The method can include receiving, via a computer network, an ad request. The method also can include retrieving ad candidates from an ad database. The method further can include determining a respective ad ranking score for each of the ad candidates, based at least in part on the ad request and respective historical retrieval scores for each of the ad candidates. In some embodiments, each of the respective historical retrieval scores for each of the ad candidates is determined at least in part by a multi-channel search engine and a respective historical search query, by: (a) determining, by a semantic search model of the multi-channel search engine, one or more semantic search results from the ad candidates and a respective semantic ranking score for each of the one or more semantic search results, based on a respective query vector embedding of the respective historical search query and a respective ad vector embedding of each of the one or more semantic search results; (b) determining, by a syntactic search model of the multi-channel search engine, one or more syntactic search results from the ad candidates and a respective syntactic ranking score for each of the one or more syntactic search results, based on the respective historical search query; (c) unifying the respective semantic ranking score for each of the one or more semantic search results; (d) unifying the respective syntactic ranking score for each of the one or more syntactic search results; and (e) merging the one or more semantic search results and the one or more syntactic search results into one or more historical ad candidates based on the respective semantic ranking score, as unified, or the respective syntactic ranking score, as unified. The one or more historical ad candidates, as merged, can comprise the ad candidates, and each of the respective historical retrieval scores for each of the ad candidates can be the respective semantic ranking score, as unified, or the respective syntactic ranking score, as unified. The method additionally can include determining one or more ad finalists based at least in part on the respective ad ranking score for each of the ad candidates. Moreover, the method can include transmitting, via the computer network, the one or more ad finalists to be displayed on a user interface. Other embodiments are described.

### TECHNICAL FIELD

This disclosure relates generally to automatically determining ads to present in a user interface.

### BACKGROUND

Existing ads search techniques for e-commerce use a single search model to determine ads related to a user's intent. Depending on the types of search models and the particular user intents, systems using existing ads search techniques do not always find the most relevant ads, and the performance of the ads is inconsistent. Therefore, systems and/or methods that can integrate multiple search models and produce consistent ad performance are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically determining ads to present in a user interface, according to an embodiment;

FIG. 4 illustrates a flow chart for a method for automatically determining ads to present in a user interface by a federated search, according to an embodiment; and

FIG. 5 illustrates activities for a method for determining a weight for an element in a formula for determining ad ranking, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DESCRIPTION OF EXAMPLES OF EMBODIMENTS

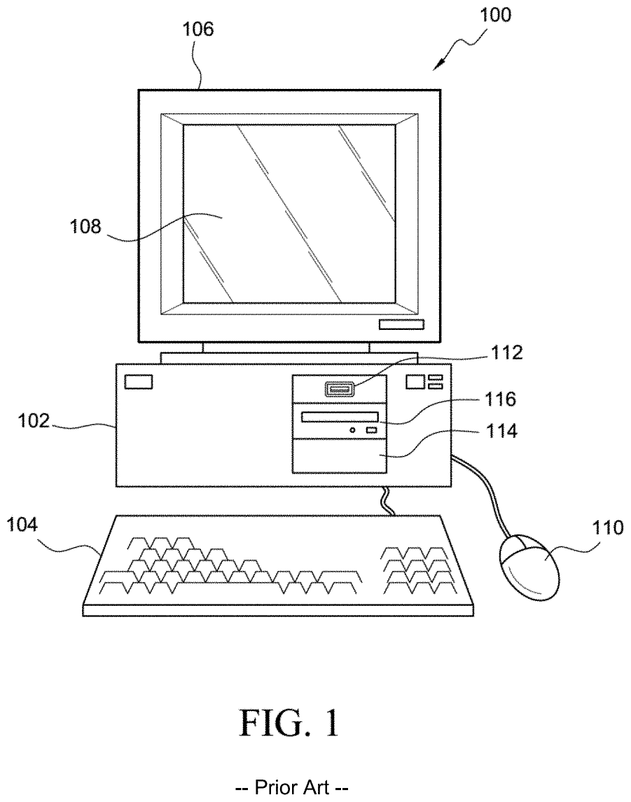

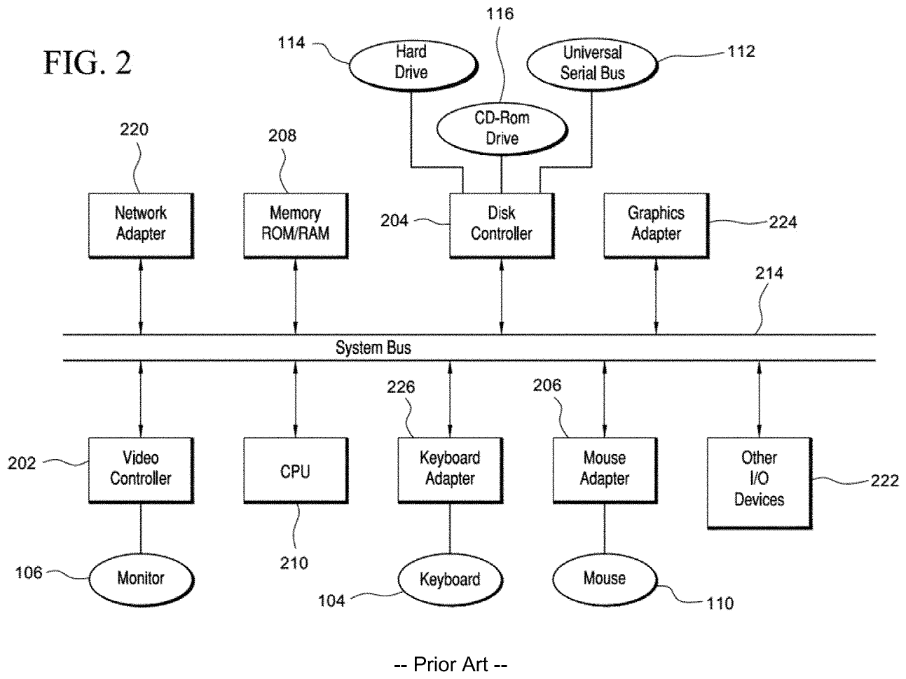

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD- ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. (Microsoft) of Redmond, Wash., United States of America, (ii) Mac® OS X by Apple Inc. (Apple) of Cupertino, Calif., United States of America, (iii) UNIX® OS, and (iv) Linux® OS. Further exemplary operating systems can comprise one of the following: (i) the iOS® operating system by Apple, (ii) the Blackberry® operating system by Research In Motion (RIM) of Waterloo, Ontario, Canada, (iii) the WebOS operating system by LG Electronics (LG) of Seoul, South Korea, (iv) the Android™ operating system developed by Google, Inc. (Google) of Mountain View, Calif., United States of America, or (v) the Windows Mobile™ operating system by Microsoft.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

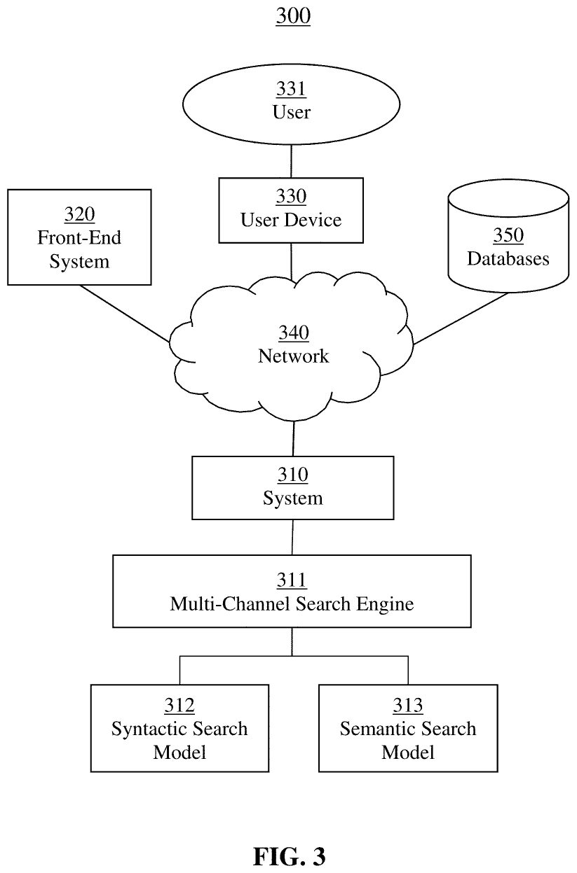

Turning ahead in the drawings, FIG. 3 illustrates a block diagram of a system 300 that can be employed for automatically determining ads to present in a user interface, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., system 310 and/or front-end system 320) and one or more user devices (e.g., user device 330) for various users (e.g., user 331). In a few embodiments, system 310 can include front-end system 320. System 310, front-end system 320, and/or user device 330 can each be a computer system, such as computer system 100 (FIG. 1), as described above, and can each be a single computer, a single server, or a cluster or collection of computers or servers, or a cloud of computers or servers. In another embodiment, a single computer system can host each of system 310, front-end system 320, and/or user device 330. In many embodiments, system 310 can be modules of computing instructions (e.g., software modules) stored at non-transitory computer readable media that operate on one or more processors. In other embodiments, system 310 can be implemented in hardware. In many embodiments, system 310 can comprise one or more systems, subsystems, servers, modules, or models. For example, system 310 can include multi-channel search engine 311, which also can be implemented in software and/or hardware and comprise one or more search models, such as syntactic search model 312 and semantic search model 313. Additional details regarding system 310, multi-channel search engine 311, syntactic search model 312, semantic search model 313, front-end system 320, and/or user device 330 are described herein.

In some embodiments, system 310 can be in data communication, through a network 340 (e.g., a computer network, a telephone network, and/or the Internet), with front-end system 320 and/or user device 330. In some embodiments, user device 330 can be used by users (e.g., user 331). In a number of embodiments, front-end system 320 can host one or more websites and/or mobile application servers. For example, front-end system 320 can host a website, or provide a server that interfaces with an application (e.g., a mobile application, a web browser, or a calendar application), on client devices (e.g., user device 330), which allow users (e.g., user 331) to browse, search, and/or purchase items (e.g., products or produces offered for sale by a retailer), in addition to other suitable activities. In a number of embodiments, front-end system 320 can generate an ad request in response to a user activity (e.g., browsing or searching items, or adding an item to cart, etc.) and transmit, via network 340, the ad request to system 310 for system 310 to determine ads to present to a user interface executed on a user device (e.g., user device 330) for a user (e.g., user 331).

In some embodiments, an internal network (e.g., network 340) that is not open to the public can be used for communications between system 310 with front-end system 320, and/or user device 330. In these or other embodiments, the operator and/or administrator of system 310 can manage system 310, the processor(s) of system 310, and/or the memory storage unit(s) of system 310 using the input device(s) and/or display device(s) of system 310.

In certain embodiments, the user devices (e.g., user device 330) can be desktop computers, laptop computers, mobile devices, and/or other endpoint devices used by one or more users (e.g., user 331). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., databases 350). The one or more databases can include an ads history database that includes information about ads that can be presented to users, as well as their respective performance data. Examples of information about an ad in the ads history database (e.g., databases 350) can include an item associated with the ad, a category for the item, one or more reviews for the item, a bid price for the ad, and so forth. Examples of the performance data for an ad can include a respective click-through-rate, a cost-per-click, an overall impression count, a recent impression count, etc.

In some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units. Further, the one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or databases 350 can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can receive, via network 340, an ad request. The ad request can be generated by front-end system 320 based on a user activity, such as browsing for items offered for sale on an e-commerce website, etc. Upon receiving the ad request, system 310 further can retrieve ad candidates from databases 350. Then, system 310 can determine a respective ad ranking score for each of the ad candidates, based at least in part on the ad request and respective historical retrieval scores for each of the ad candidates.

In a number of embodiments, system 310 can determine each of the respective historical retrieval scores for each of the ad candidates at least in part by multi-channel search engine 311 and a respective historical search query. Each of the respective historical retrieval scores for each of the ad candidates can be determined by: (a) determining, by semantic search model 313 of multi-channel search engine 311, one or more semantic search results from the ad candidates and a respective semantic ranking score for each of the one or more semantic search results, based on a respective query vector embedding of the respective historical search query and a respective ad vector embedding of each of the one or more semantic search results; (b) determining, by syntactic search model 312 of multi-channel search engine 311, one or more syntactic search results from the ad candidates and a respective syntactic ranking score for each of the one or more syntactic search results, based on the respective historical search query; (c) unifying the respective semantic ranking score for each of the one or more semantic search results; (d) unifying the respective syntactic ranking score for each of the one or more syntactic search results; and (e) merging the one or more semantic search results and the one or more syntactic search results into one or more historical ad candidates based on the respective semantic ranking score, as unified, or the respective syntactic ranking score, as unified.

In some embodiments, the one or more historical ad candidates, as merged, can comprise the ad candidates. Each of the respective historical retrieval scores for each of the ad candidates can be the respective semantic ranking score, as unified, or the respective syntactic ranking score, as unified. In certain embodiments, system 310 further can include any suitable natural-language-processing (NLP) model (e.g., BM25, TF-IDF, word2vec, GloVe, etc.) configured to generate the respective query vector embedding of the respective historical search query for each of the ad candidates for semantic search model 313.

In some embodiments, system 310 further can determine one or more ad finalists based at least in part on the respective ad ranking score for each of the ad candidates. Once the one or more ad finalists are determined, system 310 additionally can transmit, via network 340, the one or more ad finalists to be displayed on user device 310 for user 331.

Conventional systems are unable to automatically determine ads to present based on a federated search. This is because conventional systems typically use a single search model for one or more search content sources and lack the ability to integrate search results from multiple search models. Not being able to use different search models can limit a system's ability to find relevant search results. For example, semantic search models (e.g., semantic search model 313, FAISS, etc.) generally perform better for queries with a broader user intention (e.g., searching with generic keywords or descriptions, such as chips, t-shirts, bikes for adults, etc., or browsing items of a category or department, etc.), while syntactic search models (e.g., syntactic search model 312 or Apache Solr) generally produce better search results when users search for a specific item of a certain brand, size, model, color, flavor, etc. As such, using a multi-channel search engine (e.g., multi-channel search engine 311) is advantageous because system 300 and/or system 310 can take advantage of the various benefits of different search models (e.g., semantic search model 313 and syntactic search model 312) and have comprehensive search results.

Further, in many embodiments, ad search techniques provided by system 300 and/or system 310 can use and integrate various search models to advantageously provide ad search results ranked based on a universal ranking standard regardless of which search model and/or content source are used. For example, system 300 and/or system 310 can determine search results that are syntactically and/or semantically similar to a search query using two search models, unify the ranking scores of the search results into comparable values, and then merge the search results of the two search models based on their respective ranking scores, as unified.

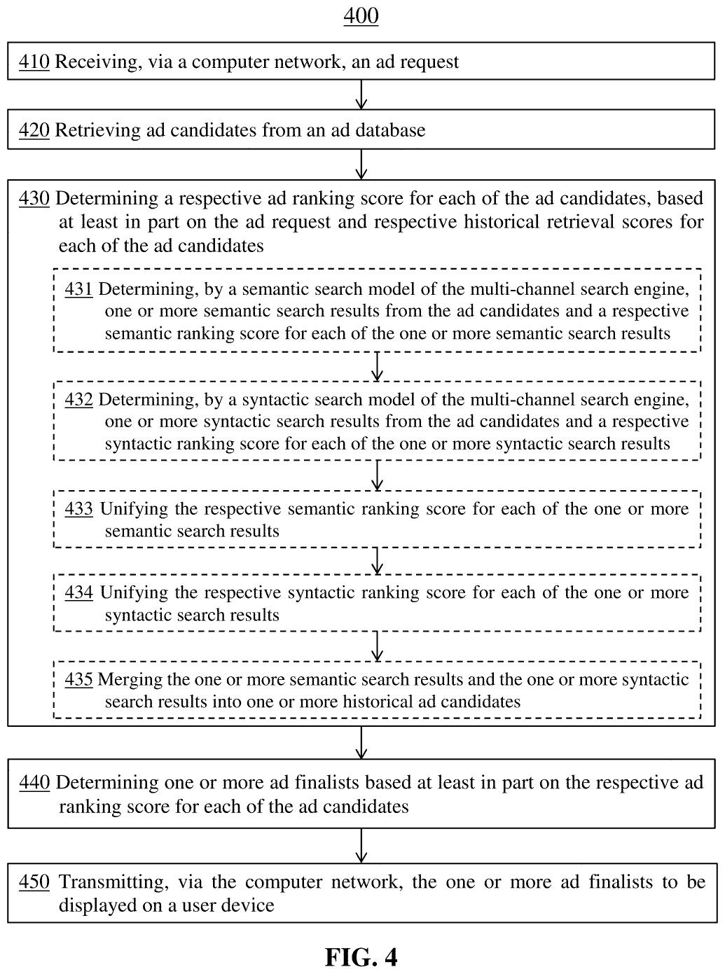

Turning ahead in the drawings, FIG. 4 illustrates a flow chart for a method 400, according to an embodiment. In many embodiments, method 400 can be implemented via execution of computing instructions on one or more processors for automatically determining an offer price for an order delivery. Method 400 is merely exemplary and is not limited to the embodiments presented herein. Method 400 can be employed in many different embodiments or examples not specifically depicted or described herein. In some embodiments, the procedures, the processes, the activities, and/or the blocks of method 400 can be performed in the order presented. In other embodiments, the procedures, the processes, the activities, and/or the blocks of method 400 can be performed in any suitable order. In still other embodiments, one or more of the procedures, the processes, the activities, and/or the blocks of method 400 can be combined or skipped.

In many embodiments, system 300 (FIG. 3) and/or system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

In many embodiments, method 400 can be performed by a computer server, such as system 300 (FIG. 3) and/or system 310 (FIG. 3), to receive, via a computer network, an ad request (block 410). The ad request can be generated by and/or received from a remote server or computer system (e.g., front-end system 320 (FIG. 3)) via a network (e.g., network 340 (FIG. 3)). In some embodiments, the ad request can be associated with one or more user activities (e.g., browsing or searching items) and can include query information, implied or expressed in the one or more user activities (e.g., one or more items or a category of the items the user is browsing, ads clicked, keywords in a search query, etc.).

In some embodiments, method 400 further can include retrieving ad candidates from an ad database (e.g., databases 350 (FIG. 3)) (block 420). In addition to the information associated with a respective item, each of the ad candidates can include information related to its respective performance and/or respective cost, such as respective historical retrieval scores, respective historical impressions (e.g., prior loadings and displays of an ad on user interfaces), respective historical clicks, a respective predicted click-through-rate, a respective average cost-per-click, respective historical auction costs, a respective predicted click-through-rate, etc.

In a number of embodiments, method 400 additionally can include determining a respective ad ranking score for each of the ad candidates, based at least in part on the ad request and respective historical retrieval scores for each of the ad candidates (block 430). Each of the respective historical retrieval scores for each of the ad candidates can be determined at least in part by a multi-channel search engine (e.g., multi-channel search engine 311 (FIG. 3)) and a respective historical search query. In some embodiments, method 400 can limit the respective historical search query for determining each of the respective historical retrieval scores for each of the ad candidates to a search query that is received, via the computer network, within a first predetermined time period (e.g., 2 weeks, a month, 60 days, etc.) prior to a current time.

In several embodiments, method 400 further can determine the respective ad ranking score for each of the ad candidates further based at least in part on a respective predicted click-through-rate for each of the ad candidates. The respective predicted click-through-rate for each of the ad candidates can be determined based on respective historical impressions and respective historical clicks for each of the ad candidates occurring within a second predetermined time period (e.g., 6 weeks, 2 months, 3 months, 50 days, 90 days, etc.) prior to a current time.

In some embodiments, method 400 further can determine the respective ad ranking score for each of the ad candidates further based at least in part on a respective average cost-per-click for each of the ad candidates. The respective average cost-per-click for each of the ad candidates can be determined based on respective historical auction costs and respective historical clicks for each of the ad candidates occurring within a third predetermined time period (e.g., 3 weeks, a month, 2 months, 3 months, etc.) prior to a current time. Limiting the respective historical search query, respective historical impressions, respective historical clicks, and/or respective historical auction costs to recent data can be advantageous because the results would reflect recent user behaviors, performance, and/or costs more accurately.

Still referring to FIG. 4, in many embodiments, method 400 further can determine each of the respective historical retrieval scores for each of the ad candidates by a semantic search model (e.g., semantic search model 313 (FIG. 3), Flexible Embedding vector retrieval, or Facebook AI Similarity Search (FAISS)) of the multi-channel search engine (e.g., multi-channel search engine 311 (FIG. 3)), one or more semantic search results from the ad candidates and a respective semantic ranking score for each of the one or more semantic search results (block 431). Method 400 can use any suitable NLP model (e.g., BM25, TF-IDF, etc.) to generate the respective query vector embedding of the respective historical search query for each of the ad candidates for the semantic search model. Moreover, method 400 can determine each of the respective historical retrieval scores for each of the ad candidates further by determining, by a syntactic search model (e.g., syntactic search model 312 (FIG. 3) or Apache Solr) of the multi-channel search engine, one or more syntactic search results from the ad candidates and a respective syntactic ranking score for each of the one or more syntactic search results (block 432). Block 432 can occur before or after block 431.

In a number of embodiments, method 400 can determine each of the respective historical retrieval scores for each of the ad candidates further by unifying the respective semantic ranking score for each of the one or more semantic search results (block 433). Unifying the respective semantic ranking score of each of the one or more semantic search results in block 433 can include normalizing the respective semantic ranking score into a predetermined range (e.g., [0, 1), [0, 1], [−1, 1], [0, 100], etc.). Block 433 occurs after block 431.

In a number of embodiments, method 400 can determine each of the respective historical retrieval scores for each of the ad candidates further by unifying the respective syntactic ranking score for each of the one or more syntactic search results (block 434). Unifying the respective syntactic ranking score of each of the one or more syntactic search results in block 434 can include normalizing the respective syntactic ranking score into the predetermined range. Block 434 occurs after block 432, and can occur before or after block 431 and/or block 433.

In some embodiments, method 400 can determine each of the respective historical retrieval scores for each of the ad candidates further by merging the one or more semantic search results and the one or more syntactic search results into one or more historical ad candidates (block 435). Merging the one or more semantic search results and the one or more syntactic search results into the one or more historical ad candidates in block 435 further can include one or more of: (a) removing one or more low-semantic-score semantic search items from the one or more semantic search results, based on one or more of: a predetermined unified semantic score threshold (e.g., 0.51, 0.75, 0.85, etc.), or a predetermined semantic search result count (e.g., 5, 10, 20, etc.); (b) removing one or more low-syntactic-score syntactic search items from the one or more syntactic search results, based on one or more of: a predetermined unified syntactic score threshold (e.g., 0.70, 0,80, 0.90, etc.), or a predetermined syntactic search result count (e.g., 5, 10, 15, etc.); (c) removing one or more low-ad-ranking-score ad items from the one or more historical ad candidates, as merged, based on one or more of: a predetermined unified universal ad score threshold (e.g., 0.80, 0.85, etc.), a predefined category ad score threshold (e.g., 0.88 for a first category, 0.85 for a second category, etc.), or a predetermined ad candidate count (e.g., 10, 20, 25, etc.); or (d) discarding duplicate ad items from the one or more historical ad candidates (e.g., discarding the duplicate ad item(s) with lower scores and keeping only the highest ranked one). Block 435 occurs after each of blocks 431, 432, 433, and 434.

In certain embodiments, method 400 further can determine the respective ad ranking score for each of the ad candidates in blocks 430 and 440 by:

(α_{category}*norm(RS)+(1−α_{category})*pCTR)*CPC,

wherein:
α_{category} is a respective weight determined based on a respective category, category, associated with each of the ad candidates;
norm(RS) is each of the respective historical retrieval scores for each of the ad candidates;
pCTR is a respective predicted click-through-rate for each of the ad candidates; and
CPC is a respective average cost-per-click for each of the ad candidates.

In a number of embodiments, method 400 further can include determining one or more ad finalists based at least in part on the respective ad ranking score for each of the ad candidates (block 440). In many embodiments, method 400 additionally can include a block 450 for transmitting, via the computer network (e.g., network 340 (FIG. 3)), the one or more ad finalists to be displayed on a user interface executed on a user device (e.g., user device 330 (FIG. 3)). For example, the one or more ad finalists can be displayed on a top panel or a side panel of a webpage for browsing or searching items at an e-commerce website.

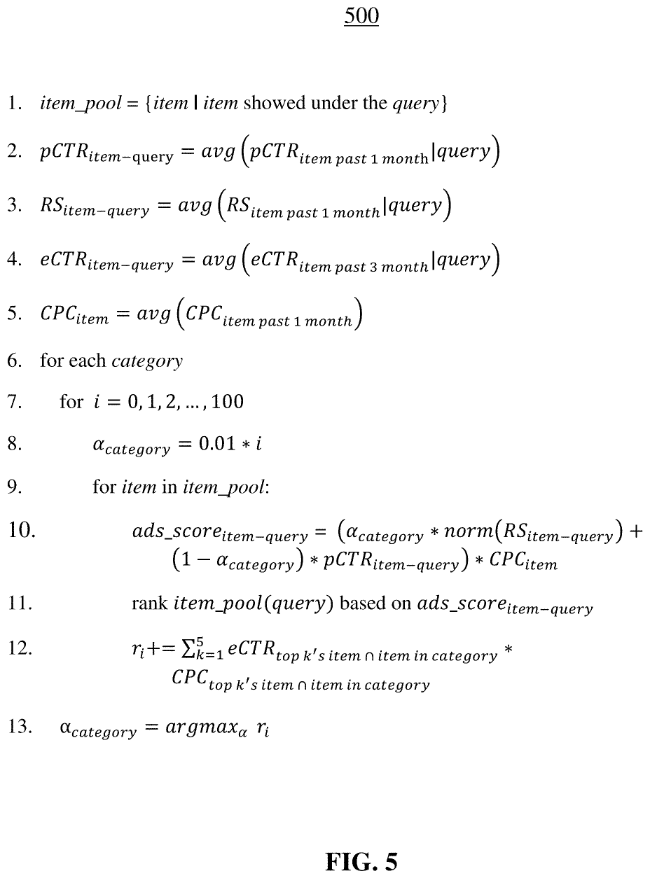

Turning ahead in the drawings, FIG. 5 illustrates activities for a method 500, according to an embodiment. In many embodiments, method 500 can be implemented via execution of computing instructions on one or more processors, and the computing instructions can be stored at one or more non-transitory computer-readable media and, when executed on the one or more processors, perform automatically determining a delivery offer price for a delivery request. Method 500 is merely exemplary and is not limited to the embodiments presented herein. Method 500 can be employed in many different embodiments or examples not specifically depicted or described herein. In some embodiments, the procedures, the processes, the activities, and/or the blocks of method 500 can be performed in the order presented. In other embodiments, the procedures, the processes, the activities, and/or the blocks of method 500 can be performed in any suitable order. In still other embodiments, one or more of the procedures, the processes, the activities, and/or the blocks of method 500 can be combined or skipped.

In many embodiments, system 300 (FIG. 3) and/or system 310 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

Referring to FIG. 5, method 500 can be performed by a computer server, such as system 300 (FIG. 3) and/or system 310 (FIG. 3), to determine a weight for an element in a formula (e.g., a formula associated with block 430 (FIG. 4) for determining the respective ad ranking score for each of the ad candidates, or the ads_score_{item-query} formula in FIG. 5). In some embodiments, method 500 can determine the respective weight for the respective category (e.g., α_{category}) associated with each of the ad candidates (e.g., item of item_pool), based on a respective average predicted click-through-rate (e.g., pCTR_{item-query}) for each of the ad candidates, a respective average retrieval score (e.g., RS_{item-query}) for each of the ad candidates, a respective average expected click-through-rate (e.g., eCTR_{item-query}) for each of the ad candidates, and a respective average cost-per-click (e.g., CPCᵢₜₑₘ) for each of the ad candidates.

In a number of embodiments, method 500 can determine the respective weight (e.g., 0.2, 0.6, etc.) for the respective category (e.g., α_{category}) by choosing the respective weight among multiple respective potential weights to generate the maximum revenue (e.g., rᵢ) for the respective category, when the revenue is determined based at least in part on the respective average expected click-through-rate for the top-ranking ads of the ad candidates in the category (e.g., eCTR_{top k's item ∩ item in category}) and the respective average cost-per-click for the top-ranking ads of the ad candidates in the respective category (e.g. CPC_{top k's item ∩ item in category}). In some embodiments, the ad candidates for method 500 can be retrieved from the ad database (e.g., databases 350 (FIG. 3)) based on a query (e.g., query) that can be determined based on the respective historical search query for each of the ad candidates and/or other ads in the ad database. The respective average predicted click-through-rate (e.g., pCTR_{item-query}) for each of the ad candidates can be determined based on the respective predicted click-through-rate for each of the ad candidates, in a first time period in the past (e.g., the past month, the past 2 months, etc.). The respective average retrieval score (e.g., RS_{item-query}) for each of the ad candidates can be determined based on the respective historical retrieval scores for each of the ad candidates in a second time period in the past (e.g., the past month, the past 2 months, etc.). The respective average expected click-through-rate for each of the ad candidates (e.g., eCTR_{item-query}) and/or the respective average expected click-through-rate for the top ranking ads of the ad candidates in the category (e.g., eCTR_{top k's item ∩ item in category}) each can be determined based on a respective historical expected click-through-rate for each of the ad candidates in a third time period in the past (e.g., the past month, the past 3 months, etc.). The respective average cost-per-click for each of the ad candidates (e.g., CPCᵢₜₑₘ) and/or the respective average cost-per-click for top-ranking ads of the ad candidates in the respective category (e.g. CPC_{top k's item ∩ item in category}) each can be determined based on one or more respective historical cost-per-clicks for each of the ad candidates in a fourth time period in the past (e.g., the past month, the past 2 months, the past 3 months, etc.).

Various embodiments can include a system for determining a delivery offer price to be used in a driver assignment process for a delivery request. The system can include one or more processors and one or more non-transitory computer-readable media storing computing instructions that, when executed on the one or more processors, cause the one or more processors to perform various acts.

In a number of embodiments, the acts can include receiving, via a computer network, an ad request. The acts further can include retrieving ad candidates from an ad database. In many embodiments, the acts additionally can include determining a respective ad ranking score for each of the ad candidates, based at least in part on the ad request and respective historical retrieval scores for each of the ad candidates. In several embodiments, the acts also can include determining one or more ad finalists based at least in part on the respective ad ranking score for each of the ad candidates. In some embodiments, the acts further can include transmitting, via the computer network, the one or more ad finalists to be displayed on a user interface.

In many embodiments, the acts further can include determining each of the respective historical retrieval scores for each of the ad candidates at least in part by a multi-channel search engine and a respective historical search query. Each of the respective historical retrieval scores for each of the ad candidates can be determined by: (a) determining, by a semantic search model of the multi-channel search engine, one or more semantic search results from the ad candidates and a respective semantic ranking score for each of the one or more semantic search results, based on a respective query vector embedding of the respective historical search query and a respective ad vector embedding of each of the one or more semantic search results; (b) determining, by a syntactic search model of the multi-channel search engine, one or more syntactic search results from the ad candidates and a respective syntactic ranking score for each of the one or more syntactic search results, based on the respective historical search query; (c) unifying the respective semantic ranking score for each of the one or more semantic search results; (d) unifying the respective syntactic ranking score for each of the one or more syntactic search results; and (e) merging the one or more semantic search results and the one or more syntactic search results into one or more historical ad candidates based on the respective semantic ranking score, as unified, or the respective syntactic ranking score, as unified. In some embodiments, the one or more historical ad candidates, as merged, can comprise the ad candidates, and each of the respective historical retrieval scores for each of the ad candidates can be: (a) the respective semantic ranking score, as unified, or (b) the respective syntactic ranking score, as unified.

Further, various embodiments can include a method being implemented via execution of computing instructions configured to run at one or more processors and stored at one or more non-transitory computer-readable media. The method can comprise receiving, via a computer network, an ad request. The method also can include retrieving ad candidates from an ad database. In many embodiments, the method further can include determining a respective ad ranking score for each of the ad candidates, based at least in part on the ad request and respective historical retrieval scores for each of the ad candidates.

In some embodiments, each of the respective historical retrieval scores for each of the ad candidates can be determined, by the method or another method or system, at least in part by a multi-channel search engine and a respective historical search query, by: (a) determining, by a semantic search model of the multi-channel search engine, one or more semantic search results from the ad candidates and a respective semantic ranking score for each of the one or more semantic search results, based on a respective query vector embedding of the respective historical search query and a respective ad vector embedding of each of the one or more semantic search results; (b) determining, by a syntactic search model of the multi-channel search engine, one or more syntactic search results from the ad candidates and a respective syntactic ranking score for each of the one or more syntactic search results, based on the respective historical search query; (c) unifying the respective semantic ranking score for each of the one or more semantic search results; (d) unifying the respective syntactic ranking score for each of the one or more syntactic search results; and (e) merging the one or more semantic search results and the one or more syntactic search results into one or more historical ad candidates based on the respective semantic ranking score, as unified, or the respective syntactic ranking score, as unified. The one or more historical ad candidates, as merged, can comprise the ad candidates. Each of the respective historical retrieval scores for each of the ad candidates can be the respective semantic ranking score, as unified, or the respective syntactic ranking score, as unified.

In a number of embodiments, the method further can include determining one or more ad finalists based at least in part on the respective ad ranking score for each of the ad candidates. In some embodiments, the method also can include transmitting, via the computer network, the one or more ad finalists to be displayed on a user interface executed on a user device.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatically determining by a federated search ads to be presented on a user interface has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. Different multi-channel search engine and/or search models may be used to determine the ad rankings. Different functions or formula also can be used for determining the ranking scores or revenues, or for normalizing the ranking scores, and so forth.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system comprising:
one or more processors; and
one or more non-transitory computer-readable media storing computing instructions that, when executed on the one or more processors, cause the one or more processors to perform:
receiving, from a user computer and via a computer network, an ad request;
retrieving ad candidates from an ad database;
using a multi-channel search engine to determine a respective ad ranking score for each of the ad candidates, comprising:
using a semantic search model of the multi-channel search engine to determine one or more semantic search results from the ad candidates and a respective semantic ranking score for each of the one or more semantic search results, based on a respective query vector embedding of a respective historical search query for each of the ad candidates and a respective ad vector embedding of each of the one or more semantic search results;
using a syntactic search model of the multi-channel search engine to determine one or more syntactic search results from the ad candidates and a respective syntactic ranking score for each of the one or more syntactic search results, based on the respective historical search query for each of the ad candidates;
making the one or more semantic search results and the one or more syntactic search results comparable with each other by:
unifying the respective semantic ranking score for each of the one or more semantic search results; and
unifying the respective syntactic ranking score for each of the one or more syntactic search results; and
after making the one or more semantic search results and the one or more syntactic search results comparable with each other, merging the one or more semantic search results and the one or more syntactic search results into one or more historical ad candidates based on the respective semantic ranking score, as unified, or the respective syntactic ranking score, as unified, wherein:
the respective ad ranking score for each of the ad candidates is determined based at least in part on the respective semantic ranking score, as unified, or the respective syntactic ranking score, as unified;
determining one or more ad finalists from the ad candidates based at least in part on the respective ad ranking score for each of the ad candidates; and
transmitting, via the computer network, the one or more ad finalists to be displayed on a user interface of the user computer.

2. The system in claim 1, wherein:
the respective historical search query is received, via the computer network, within a first predetermined time period prior to a current time.

3. The system in claim 1, wherein:
unifying the respective semantic ranking score for each of the one or more semantic search results further comprises normalizing the respective semantic ranking score into a predetermined range; and
unifying the respective syntactic ranking score for each of the one or more syntactic search results further comprises normalizing the respective syntactic ranking score into the predetermined range.

4. The system in claim 1, wherein:
merging the one or more semantic search results and the one or more syntactic search results into the one or more historical ad candidates further comprises one or more of:
removing one or more low-semantic-score semantic search items from the one or more semantic search results, based on one or more of: a predetermined unified semantic score threshold, or a predetermined semantic search result count;
removing one or more low-syntactic-score syntactic search items from the one or more syntactic search results, based on one or more of: a predetermined unified syntactic score threshold, or a predetermined syntactic search result count;
removing one or more low-ad-ranking-score ad items from the one or more historical ad candidates, as merged, based on one or more of: a predetermined unified ad score threshold, or a predetermined ad candidate count; or discarding duplicate ad items from the one or more historical ad candidates.

5. The system in claim 1, wherein:
using the multi-channel search engine to determine the respective ad ranking score for each of the ad candidates further comprises determining the respective ad ranking score for each of the ad candidates based at least in part on: (a) the respective semantic ranking score, as unified, or the respective syntactic ranking score, as unified, and (b) a respective predicted click-through-rate for each of the ad candidates.

6. The system in claim 5, wherein:
the respective predicted click-through-rate for each of the ad candidates is determined based on respective historical impressions and respective historical clicks for each of the ad candidates occurring within a second predetermined time period prior to a current time.

7. The system in claim 1, wherein:
using the multi-channel search engine to determine the respective ad ranking score for each of the ad candidates further comprises determining the respective ad ranking score for each of the ad candidates based at least in part on: (a) the respective semantic ranking score, as unified, or the respective syntactic ranking score, as unified, and (b) a respective average cost-per-click for each of the ad candidates.

8. The system in claim 7, wherein:
the respective average cost-per-click for each of the ad candidates is determined based on respective historical auction costs and respective historical clicks for each of the ad candidates occurring within a third predetermined time period prior to a current time.

9. The system in claim 1, wherein:
using the multi-channel search engine to determine the respective ad ranking score for each of the ad candidates further comprises determining the respective ad ranking score by:
(α_{category}*norm(RS)+(1−α_{category})*pCTR)*CPC,
wherein:
α_{category} is a respective weight determined based on a respective category, category, associated with each of the ad candidates;
norm(RS) is the respective semantic ranking score, as unified, or the respective syntactic ranking score, as unified, for each of the ad candidates;
pCTR is a respective predicted click-through-rate for each of the ad candidates; and
CPC is a respective average cost-per-click for each of the ad candidates.

10. The system in claim 9, wherein:
determining the respective ad ranking score for each of the ad candidates further comprises determining the respective weight, α_{category}, for the respective category associated with each of the ad candidates, based on a respective average predicted click-through-rate for each of the ad candidates, a respective average retrieval score for each of the ad candidates, a respective average expected click-through-rate for each of the ad candidates, and a respective average cost-per-click for each of the ad candidates.

11. A method being implemented via execution of computing instructions configured to run at one or more processors and stored at one or more non-transitory computer-readable media, the method comprising:
receiving, from a user computer and via a computer network, an ad request;
retrieving ad candidates from an ad database;
using a multi-channel search engine to determine a respective ad ranking score for each of the ad candidates, comprising:
using a semantic search model of the multi-channel search engine to determine one or more semantic search results from the ad candidates and a respective semantic ranking score for each of the one or more semantic search results, based on a respective query vector embedding of a respective historical search query for each of the ad candidates and a respective ad vector embedding of each of the one or more semantic search results;
using a syntactic search model of the multi-channel search engine to determine one or more syntactic search results from the ad candidates and a respective syntactic ranking score for each of the one or more syntactic search results, based on the respective historical search query for each of the ad candidates;
making the one or more semantic search results and the one or more syntactic search results comparable with each other by:
unifying the respective semantic ranking score for each of the one or more semantic search results; and
unifying the respective syntactic ranking score for each of the one or more syntactic search results; and
after making the one or more semantic search results and the one or more syntactic search results comparable with each other, merging the one or more semantic search results and the one or more syntactic search results into one or more historical ad candidates based on the respective semantic ranking score, as unified, or the respective syntactic ranking score, as unified, wherein:
the respective ad ranking score for each of the ad candidates is determined based at least in part on the respective semantic ranking score, as unified, or the respective syntactic ranking score, as unified;
determining one or more ad finalists from the ad candidates based at least in part on the respective ad ranking score for each of the ad candidates; and
transmitting, via the computer network, the one or more ad finalists to be displayed on a user interface of the user computer.

12. The method in claim 11, wherein:
the respective historical search query is received, via the computer network, within a first predetermined time period prior to a current time.

13. The method in claim 11, wherein:
unifying the respective semantic ranking score for each of the one or more semantic search results further comprises normalizing the respective semantic ranking score into a predetermined range; and
unifying the respective syntactic ranking score for each of the one or more syntactic search results further comprises normalizing the respective syntactic ranking score into the predetermined range.

14. The method in claim 11, wherein:
merging the one or more semantic search results and the one or more syntactic search results into the one or more historical ad candidates further comprises one or more of:
removing one or more low-semantic-score semantic search items from the one or more semantic search results, based on one or more of: a predetermined unified semantic score threshold, or a predetermined semantic search result count;
removing one or more low-syntactic-score syntactic search items from the one or more syntactic search results, based on one or more of: a predetermined unified syntactic score threshold, or a predetermined syntactic search result count;
removing one or more low-ad-ranking-score ad items from the one or more historical ad candidates, as merged, based on one or more of: a predetermined unified ad score threshold, or a predetermined ad candidate count; or
discarding duplicate ad items from the one or more historical ad candidates.

15. The method in claim 11, wherein:
using the multi-channel search engine to determine the respective ad ranking score for each of the ad candidates further comprises determining the respective ad ranking score for each of the ad candidates based at least in part on: (a) the respective semantic ranking score, as unified, or the respective syntactic ranking score, as unified, and (b) a respective predicted click-through-rate for each of the ad candidates.

16. The method in claim 15, wherein:
the respective predicted click-through-rate for each of the ad candidates is determined based on respective historical impressions and respective historical clicks for each of the ad candidates occurring within a second predetermined time period prior to a current time.

17. The method in claim 11, wherein:
using the multi-channel search engine to determine the respective ad ranking score for each of the ad candidates further comprises determining the respective ad ranking score for each of the ad candidates based at least in part on: (a) the respective semantic ranking score, as unified, or the respective syntactic ranking score, as unified, and (b) a respective average cost-per-click for each of the ad candidates.

18. The method in claim 17, wherein:
the respective average cost-per-click for each of the ad candidates is determined based on respective historical auction costs and respective historical clicks for each of the ad candidates occurring within a third predetermined time period prior to a current time.

19. The method in claim 11, wherein:
using the multi-channel search engine to determine the respective ad ranking score for each of the ad candidates further comprises determining the respective ad ranking score by:
α_{category}*norm(RS)+(1−α_{category})*pCTR)*CPC,
wherein:
α_{category} is a respective weight determined based on a respective category, category, associated with each of the ad candidates;
norm(RS) is the respective semantic ranking score, as unified, or the respective syntactic ranking score, as unified, for each of the ad candidates;
pCTR is a respective predicted click-through-rate for each of the ad candidates; and
CPC is a respective average cost-per-click for each of the ad candidates.

20. The method in claim 19, wherein:
determining the respective ad ranking score for each of the ad candidates further comprises determining the respective weight, α_{category}, for the respective category associated with each of the ad candidates, based on a respective average predicted click-through-rate for each of the ad candidates, a respective average retrieval score for each of the ad candidates, a respective average expected click-through-rate for each of the ad candidates, and a respective average cost-per-click for each of the ad candidates.
